(19) United States
(12) Patent Application Publication
(10) Pub. No.: US 2016/0374401 A1
(43) Pub. Date: Dec. 29, 2016

(54) ELECTRONIC CIGARETTE OIL VAPORIZATION METHOD, ELECTRONIC CIGARETTE CONTROL CIRCUIT, AND ELECTRONIC CIGARETTE

(71) Applicant: HUIZHOU KIMREE TECHNOLOGY CO., LTD. SHENZHEN BRANCH, SHENZHEN (CN)

(72) Inventor: Qiuming LIU, Huizhou (CN)

(73) Assignee: HUIZHOU KIMREE TECHNOLOGY CO., LTD. SHENZHEN BRANCH, Shenzhen (CN)

(21) Appl. No.: 15/263,607

(22) Filed: Sep. 13, 2016

Related U.S. Application Data
(63) Continuation of application No. PCT/CN2014/074636, filed on Apr. 2, 2014.

(30) Foreign Application Priority Data
Mar. 18, 2014 (CN) 201410100908.X

(51) Int. Cl. A24F 47/00; H05B 1/02

(52) U.S. Cl. CPC A24F 47/008; H05B 1/0244; H05B 2203/021; G06F 3/16

(57) ABSTRACT

An electronic cigarette oil vaporization method, an electronic cigarette control circuit, and an electronic cigarette are provided. The method includes: a smoking switch generating according to a user's operation a trigger signal; a microcontroller module receiving the trigger signal and according to same, turning on one of a plurality of vaporization control switches electrically connected to the microcontroller module; a heating wire electrically connected to the activated vaporization control switch vaporizing the electronic cigarette oil to supply smoke to a user to take in.

### CROSS REFERENCE OF RELATED APPLICATION

This application is a continuation of International Application No. PCT/CN2014/074636, titled “ELECTRONIC CIGARETTE OIL VAPORIZATION METHOD, ELECTRONIC CIGARETTE CONTROL CIRCUIT, AND ELECTRONIC CIGARETTE”, filed on Apr. 2, 2014, which claims the priority to Chinese Patent Application No. 201410100908.X, titled “ELECTRONIC CIGARETTE OIL VAPORIZATION METHOD AND ELECTRONIC CIGARETTE CONTROL CIRCUIT”, filed on Mar. 18, 2014 with the State Intellectual Property Office of People's Republic of China, both of which are hereby incorporated by reference in entirety.

### FIELD

The disclosure relates to the technical field of electronic cigarette, and particularly to an electronic cigarette oil vaporization method, an electronic cigarette control circuit, and an electronic cigarette.

### BACKGROUND

In the conventional art, an electronic cigarette vaporizes electronic cigarette oil by means of a vaporizer in the electronic cigarette, to generate smoke for a user to take in. The vaporization is controlled by a user pressing a push-key switch, or by means of an airflow-sensitive switch which is able to sense a smoking action of the user. The conventional electronic cigarette generally includes one or more vaporizers, each of which is filled with electronic cigarette oil with a certain flavor. When a press action of the user is sensed by the push-key switch or a smoking action of the user is sensed by the airflow-sensitive switch, the vaporizer vaporizes electronic cigarette oil with a single flavor.

Therefore, in a case that the user wants to taste electronic cigarette oil with a certain flavor, or to find electronic cigarette oil with a flavor favored by the user, he or she needs to smoke multiple electronic cigarettes with different flavors or to set a complicated adjustment mechanism to choose the flavor, thus the operation is troublesome and the user experience is poor.

### SUMMARY

According to the embodiments, it is provided an electronic cigarette oil vaporization method, an electronic cigarette control circuit, and an electronic cigarette.

An electronic cigarette oil vaporization method is provided. The method includes generating, by a smoking switch module configured to generate a trigger signal according to an operation of a user, the trigger signal according to the operation of the user. The method further includes receiving, by a microcontroller module, the trigger signal. The method further includes receiving, by a microcontroller module, the trigger signal. The method further includes turning on, by the microcontroller module, one of multiple vaporization control switches which are electrically connected to the microcontroller module in response to the trigger signal. The method further includes vaporizing, by a heating wire among multiple heating wires which is electrically connected to the turned-on vaporization control switch, electronic cigarette oil to supply smoke for the user to take in, where the multiple heating wires correspond to the plurality of vaporization control switches and a variety of electronic cigarette oil respectively.

In the electronic cigarette oil vaporization method, the turning on, by the microcontroller module, one of the multiple vaporization control switches which are electrically connected to the microcontroller module in response to the trigger signal may include: on every detection of the trigger signal by the microcontroller module, turning on, by the microcontroller module, one of the multiple vaporization control switches which are electrically connected to the microcontroller module for one time in response to the detected trigger signal, where the multiple vaporization control switches are turned on sequentially in response to the trigger signal. Alternatively, the turning on, by the microcontroller module, one of the multiple vaporization control switches which are electrically connected to the microcontroller module in response to the trigger signal may include: on every detection of the trigger signal by the microcontroller module, turning on, by the microcontroller module, one of the multiple vaporization control switches which are electrically connected to the microcontroller module for one time in response to the detected trigger signal, where the multiple vaporization control switches are turned on randomly in response to the trigger signal.

The electronic cigarette oil vaporization method may further include generating, by a first setting switch electrically connected to the microcontroller module, a first control instruction according to a pressing operation of the user. The electronic cigarette oil vaporization method may further include receiving, by the microcontroller module, the first control instruction. The turning on, by the microcontroller module, one of the multiple vaporization control switches which are electrically connected to the microcontroller module in response to the trigger signal may include: in a case that it is detected by the microcontroller module that the trigger signal generated by the smoking switch module is received by the microcontroller module, turning on, by the microcontroller module, one of the multiple vaporization control switches which are electrically connected to the microcontroller module for one time in response to the detected trigger signal and based on the first control instruction, where the multiple vaporization control switches are turned on sequentially in response to the trigger signal.

The electronic cigarette oil vaporization method may further include generating, by a second setting switch electrically connected to the microcontroller module, a second control instruction according to a pressing operation of the user. The electronic cigarette oil vaporization method may further include receiving, by the microcontroller module, the second control instruction. The turning on, by the microcontroller module, one of the multiple vaporization control switches which are electrically connected to the microcontroller module in response to the trigger signal may include: in a case that it is detected by the microcontroller module that the trigger signal generated by the smoking switch module is received by the microcontroller module, turning on, by the microcontroller module, one of the multiple vaporization control switches which are electrically connected to the microcontroller module for one time in response to the detected trigger signal and based on the second control instruction, where the multiple vaporization control switches are turned on randomly in response to the trigger signal.

In the electronic cigarette oil vaporization method, the turning on, by the microcontroller module, one of the multiple vaporization control switches which are electrically connected to the microcontroller module in response to the trigger signal may include turning on, by the microcontroller module, one of the multiple vaporization control switches which are electrically connected to the microcontroller module in response to the trigger signal, and determining, by the microcontroller module, the turned-on vaporization control switch as a target vaporization control switch. The method may further include generating, by a third setting switch electrically connected to the microcontroller module, a third control instruction according to a pressing operation of the user. The method may further include receiving, by the microcontroller module, the third control instruction. The method may further include: in a case that it is detected by the microcontroller module that the trigger signal generated by the smoking switch module is received by the microcontroller module, controlling, by the microcontroller module, the target vaporization control switch to remain on in response to the detected trigger signal and based on the third control instruction.

In the electronic cigarette oil vaporization method, the vaporizing, by the heating wire electrically connected to the turned-on vaporization control switch, the electronic cigarette oil to supply smoke for the user to take in may include determining, by the microcontroller module, a target flavor of the electronic cigarette oil vaporized by the heating wire electrically connected to the turned-on vaporization control switch. The vaporizing, by the heating wire electrically connected to the turned-on vaporization control switch, the electronic cigarette oil to supply smoke for the user to take in may further include displaying, by the microcontroller module, the target flavor in a form of text by means of a display screen electrically connected to the microcontroller module. Alternatively, the vaporizing, by the heating wire electrically connected to the turned-on vaporization control switch, the electronic cigarette oil to supply smoke for the user to take in may further include playing, by the microcontroller module, the target flavor in a form of voice by means of a sound generator electrically connected to the microcontroller module.

An electronic cigarette control circuit is provided for implementing any of the electronic cigarette oil vaporization methods. The electronic cigarette control circuit includes a battery, the smoking switch module, a heating wire assembly, a vaporization control switch module and the microcontroller module. The heating wire assembly includes the multiple heating wires. The vaporization control switch module includes the multiple vaporization control switches electrically connected to the heating wires and the battery respectively. The microcontroller module is electrically connected to the battery, the smoking switch module and the vaporization control switch module respectively, to turn on one of the multiple vaporization control switches which are electrically connected to the microcontroller module in response to the trigger signal.

The electronic cigarette control circuit may further include at least one of the first setting switch electrically connected to the microcontroller module and configured to enable the microcontroller module to sequentially turn on the multiple vaporization control switches, and the second setting switch electrically connected to the microcontroller module and configured to enable the microcontroller module to randomly turn on the multiple vaporization control switches.

The electronic cigarette control circuit may further include the third setting switch electrically connected to the microcontroller module and configured to enable the microcontroller module to control the target vaporization control switch to remain on.

The electronic cigarette control circuit may further include at least one of the display screen electrically connected to the microcontroller module and configured to prompt to the user the target flavor of the electronic cigarette oil vaporized by the heating wire electrically connected to the turned-on vaporization control switch in a form of text, and the sound generator electrically connected to the microcontroller module and configured to prompt to the user the target flavor of the electronic cigarette oil vaporized by the heating wire electrically connected to the turned-on vaporization control switch in a form of voice.

The electronic cigarette control circuit may further include at least one of a first light-emitting element electrically connected to the microcontroller module and configured to simulate a smoking scene, and a second light-emitting element electrically connected to the microcontroller module and configured to indicate whether an operation of a user is received by the smoking switch module.

The electronic cigarette control circuit may further include a capacitor electrically connected to the microcontroller module and configured to power the microcontroller module in a case that the heating wire is shorted.

In the electronic cigarette control circuit, the smoking switch module may include an airflow-sensitive switch configured to generate the trigger signal according to a smoking action of the user. Alternatively, the smoking switch module may include a push-key switch configured to receive a pressing operation of the user and generate the trigger signal according to the received pressing operation.

In the electronic cigarette control circuit, the vaporization control switch module may include a relay, a field effect transistor, or a triode.

An electronic cigarette is provided for implementing the electronic cigarette oil vaporization method. The electronic cigarette includes an electronic cigarette body. The electronic cigarette body is provided with an electronic cigarette oil receiving volume for storing the electronic cigarette oil, a vaporizer for receiving the multiple heating wires, and a battery rod assembly configured to power the vaporizer. The battery rod assembly is provided with a battery, the microcontroller module, the smoking switch module, and the multiple vaporization control switches which are electrically connected to the battery and the microcontroller module respectively. Different vaporization control switches are electrically connected to different heating wires.

In the electronic cigarette, the electronic cigarette oil receiving volume may be a first electronic cigarette oil bottle, where multiple first electronic cigarette oil bottles are configured to store the electronic cigarette oil with different flavors, and connected to the vaporizer to enable different heating wires to vaporize the electronic cigarette oil in different first electronic cigarette oil bottles. Alternatively, multiple electronic cigarette oil receiving volumes are provided in a second electronic cigarette oil bottle, where the multiple electronic cigarette oil receiving volumes are isolated from each other in a sealed manner and configured to store the electronic cigarette oil with different flavors, where the second electronic cigarette oil bottle is connected to the vaporizer to enable different heating wires to vaporize the electronic cigarette oil in different electronic cigarette oil receiving volumes.

As can be seen from the above technical solution, an electronic cigarette oil vaporization method, an electronic cigarette control circuit, and an electronic cigarette are provided according to the embodiments. The electronic cigarette oil vaporization method includes: generating, by a smoking switch module, a trigger signal according to an operation of a user; receiving, by a microcontroller module, the trigger signal; turning on, by the microcontroller module, one of multiple vaporization control switches which are electrically connected to the microcontroller module in response to the trigger signal; and vaporizing, by a heating wire electrically connected to the turned-on vaporization control switch, electronic cigarette oil to supply smoke for the user to take in. With the embodiments, the microcontroller module can control different heating wires to vaporize electronic cigarette oil with different flavors. Further, the procedure of controlling, by the microcontroller module, different heating wires to vaporize electronic cigarette oil with different flavors is simple, eliminating the need for complicated adjustment mechanism, thereby making sampling smokes convenient for the user, making the smoking process more interesting for the user, and improving user experience.

### BRIEF DESCRIPTION OF THE DRAWINGS

FIG. 1 is a flow chart illustrating steps of an electronic cigarette oil vaporization method according to a first preferred embodiment;

FIG. 2 is a flow chart illustrating steps of an electronic cigarette oil vaporization method according to another preferred embodiment;

FIG. 3 is a schematic structural diagram of an electronic cigarette control circuit according to a preferred embodiment;

FIG. 4 is a flow chart illustrating steps of an electronic cigarette oil vaporization method according to another preferred embodiment;

FIG. 5 is a flow chart illustrating steps of an electronic cigarette oil vaporization method according to another preferred embodiment;

FIG. 6 is a schematic structural diagram of an electronic cigarette control circuit according to another preferred embodiment;

FIG. 7 is a flow chart illustrating steps of an electronic cigarette oil vaporization method according to another preferred embodiment;

FIG. 8 is a flow chart illustrating steps of an electronic cigarette oil vaporization method according to another preferred embodiment;

FIG. 9 is a schematic diagram illustrating the structure and modules of an electronic cigarette control circuit according to a preferred embodiment;

FIG. 10 is a schematic diagram illustrating the structure and modules of an electronic cigarette control circuit according to another preferred embodiment;

FIG. 11 is a schematic diagram illustrating the structure and modules of an electronic cigarette control circuit according to another preferred embodiment;

FIG. 12 is a schematic diagram illustrating the structure and modules of an electronic cigarette control circuit according to another preferred embodiment; and

FIG. 13 is a schematic structural diagram illustrating an overall cross section of an electronic cigarette according to a preferred embodiment.

### DETAILED DESCRIPTION OF THE EMBODIMENTS

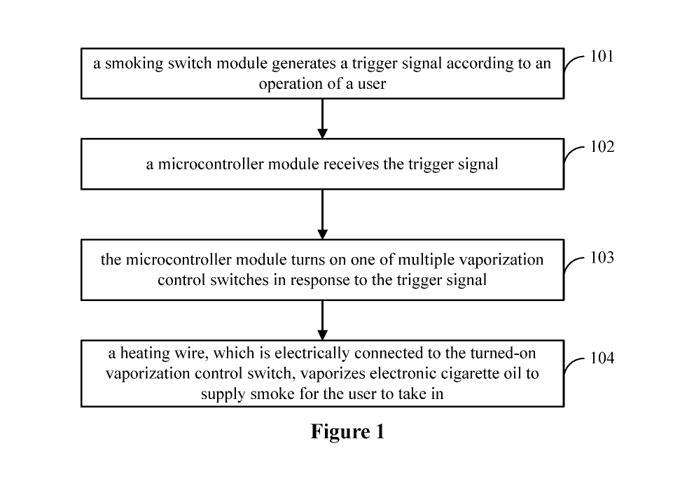

In a first embodiment, an electronic cigarette oil vaporization method is described, for enabling the electronic cigarette to vaporize electronic cigarette oil with different flavors, in order to make sampling smokes convenient for the user. In the following, the electronic cigarette oil vaporization method according to the first embodiment is described in detail in conjunction with FIG. 1.

In step 101, a smoking switch module generates a trigger signal according to an operation of a user.

The smoking switch module is configured to generate the trigger signal according to the operation of the user.

For a specific structure of the smoking switch module, reference may be made to an eighth embodiment, and the description thereof is omitted in this embodiment.

In step 102, a microcontroller module receives the trigger signal.

In step 103, the microcontroller module turns on one of multiple vaporization control switches in response to the trigger signal.

In this embodiment, the multiple vaporization control switches are provided in the electronic cigarette and electrically connected to the microcontroller module respectively.

The microcontroller module turns on a corresponding vaporization control switch in response to the trigger signal received by the microcontroller module.

The microcontroller module turns on only one vaporization control switch electrically connected thereto at a time in response to the trigger signal, so that the electronic cigarette vaporizes electronic cigarette oil with a single flavor at a time according to a smoking action of the user.

In 104, a heating wire, which is electrically connected to the turned-on vaporization control switch, vaporizes electronic cigarette oil to supply smoke for the user to take in.

In this embodiment, a variety of electronic cigarette oil is stored in the electronic cigarette in advance. Multiple heating wires in the electronic cigarette which are configured to vaporize the electronic cigarette oil respectively correspond to the multiple vaporization control switches and the variety of electronic cigarette oil. Preferably, different heating wires correspond to electronic cigarette oil with different flavors, so that each heating wire may vaporize electronic cigarette oil with a respective flavor, thereby generating smoke with a respective flavor.

As can be seen from step 103, the microcontroller module turns on only one vaporization control switch electrically connected thereto at a time in response to the trigger signal, so that only one of the multiple heating wires in the electronic cigarette vaporizes electronic cigarette oil with a single flavor at a time in response to the trigger signal. Therefore, in each smoking, the user may take in smoke with a different flavor.

In this embodiment, the microcontroller module turns on the vaporization control switch in response to the trigger signal. The microcontroller module turns on only one of the vaporization control switches which are electrically connected thereto at a time, so that the heating wire electrically connected to the turned-on vaporization control switch vaporizes electronic cigarette oil. Since the microcontroller module may turn on multiple vaporization control switches, to which heating wires configured to vaporize electronic cigarette oil with different flavors are electronically connected respectively, the microcontroller module may control the heating wires to vaporize electronic cigarette oil with different flavors, thereby making sampling smokes convenient for the user, and improving user smoking experience.

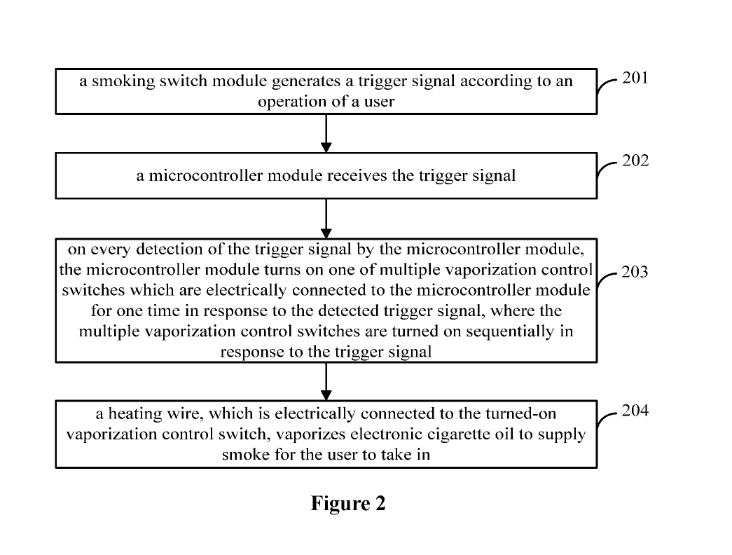

In a second embodiment, it is described in conjunction with FIG. 2 how the microcontroller module controls the multiple heating wires to vaporize the electronic cigarette oil sequentially and cyclically in response to the trigger signal.

In step 201, the smoking switch module generates the trigger signal according to an operation of a user.

The smoking switch module may be:

an airflow-sensitive switch configured to generate the trigger signal according to a smoking action of the user; or

a push-key switch configured to receive a pressing operation of the user and generate the trigger signal according to the received pressing operation.

In this embodiment, the description is given by taking the airflow-sensitive switch serving as the smoking switch module as an example.

In step 202, the microcontroller module receives the trigger signal.

The procedure of step 202 in this embodiment is the same as the procedure of step 102 shown in FIG. 1, and the detailed description thereof is omitted.

In step 203, on every detection of the trigger signal by the microcontroller module, the microcontroller module turns on one of the multiple vaporization control switches which are electrically connected to the microcontroller module for one time in response to the detected trigger signal. The multiple vaporization control switches are turned on sequentially in response to the trigger signal.

In this embodiment, on every detection of the trigger signal by the microcontroller module, the microcontroller module turns on one of the multiple vaporization control switches which are electrically connected to the microcontroller module in response to the detected trigger signal.

In other words, on every detection of the trigger signal by the microcontroller module, the microcontroller module turns on one vaporization control switch, and the multiple vaporization control switches are turned on sequentially.

In this embodiment, the microcontroller module may sequence all of the vaporization control switches electrically connected thereto in advance, so that the microcontroller module turns on the vaporization control switches sequentially and cyclically in response to trigger signals generated by the airflow-sensitive switch at multiple times.

There is no limitation on the manner in which the microcontroller module determines the priority the vaporization control switches for sequencing in this embodiment. For example, the microcontroller module may determine the priority of the vaporization control switches by receiving an operation of a user. Alternatively, the priority of the vaporization control switches may be set by the manufacturer at the factory.

When it is detected by the airflow-sensitive switch that the user takes in a first flow of smoke, the microcontroller module turns on the first one of multiple sequenced vaporization control switches;

when it is detected by the airflow-sensitive switch that the user takes in a second flow of smoke, the microcontroller module turns on the second one of the multiple sequenced vaporization control switches;

until all of the vaporization control switches which are electrically connected to the microcontroller module are turned on for one time sequentially.

When it is detected by the airflow-sensitive switch that the user smokes again, the vaporization control switches are turned on in the above sequence. That is, the microcontroller module turns on all of the vaporization control switches which are electrically connected thereto sequentially and cyclically in response to the trigger signal generated by the airflow-sensitive switch.

In step 204, the heating wire, which is electrically connected to the turned-on vaporization control switch, vaporizes electronic cigarette oil to supply smoke for the user to take in.

Since the microcontroller module turns on the multiple vaporization control switches sequentially, heating wires which are electrically connected to the vaporization control switches respectively vaporize electronic cigarette oil sequentially and cyclically. That is, the order in which the heating wires vaporize the electronic cigarette oil coincides with the order in which the vaporization control switches are turned on.

Since the multiple vaporization control switches are used for vaporizing electronic cigarette oil with different flavors, the user may take in smoke with different flavors.

It is to be noted that, the case where different heating wires are used for vaporizing electronic cigarette oil with different flavors in this embodiment is presented by way of illustration and not limitation. For example, if electronic cigarette oil with a certain flavor is preferred by the user, the number of heating wires for vaporizing the electronic cigarette oil with the certain flavor which is preferred by the user may be set to be larger than the number of heating wires for vaporizing electronic cigarette oil with other flavors. There is no limitation on the specific configuration, so long as the microcontroller may control different heating wires to operate sequentially and cyclically.

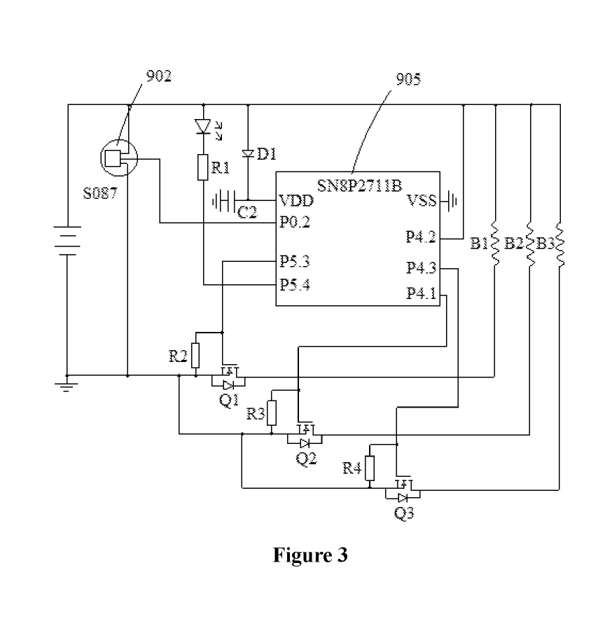

For better understanding of the embodiment, the embodiment is described in detail in the following in conjunction with a specific application scenario shown in FIG. 3.

Vaporization control switches Q1, Q2 and Q3 are electrically connected to the microcontroller module 905.

A heating wire B1, which may be used for vaporizing mint-flavored electronic cigarette oil, is electrically connected to the vaporization control switch Q1.

A heating wire B2, which may be used for vaporizing strawberry-flavored electronic cigarette oil, is electrically connected to the vaporization control switch Q2.

A heating wire B3, which may be used for vaporizing coffee-flavored electronic cigarette oil, is electrically connected to the vaporization control switch Q3.

The microcontroller module 905 determines in advance that the vaporization control switch Q1, the vaporization control switch Q2 and the vaporization control switch Q3 are turned on in the sequence listed.

When sensing an action of the user to take in a first flow of smoke, the airflow-sensitive switch 902 generates a first trigger signal.

The microcontroller module 905 receives the first trigger signal and outputs a high-level signal in response to the first trigger signal to turn on the vaporization control switch Q1.

A battery electrically connected to the vaporization control switch Q1 powers the heating wire B1 to enable the heating wire B1 to vaporize the mint-flavored electronic cigarette oil.

As a result, the user may take in mint-flavored smoke.

Preferably, the microcontroller module 905 may control a first light-emitting element, which is configured to simulate a smoking scene, to emit light with intensity gradually increasing with the intake of the smoke.

When sensing an action of the user to take in a second flow of smoke, the airflow-sensitive switch 902 generates a second trigger signal.

The microcontroller module 905 receives the second trigger signal and outputs a high-level signal in response to the second trigger signal to turn on the vaporization control switch Q2.

A battery electrically connected to the vaporization control switch Q2 powers the heating wire B2 to enable the heating wire B2 to vaporize the strawberry-flavored electronic cigarette oil.

As a result, the user may take in strawberry-flavored smoke.

The microcontroller module 905 may control the first light-emitting element, which is configured to simulate a smoking scene, to emit light with intensity gradually increasing with the intake of the smoke.

When sensing an action of the user to take in a third flow of smoke, the airflow-sensitive switch 902 generates a third trigger signal.

The microcontroller module 905 receives the third trigger signal and outputs a high-level signal in response to the third trigger signal to turn on the vaporization control switch Q3.

A battery electrically connected to the vaporization control switch Q3 powers the heating wire B3 to enable the heating wire B3 to vaporize the coffee-flavored electronic cigarette oil.

As a result, the user is may take in coffee-flavored smoke.

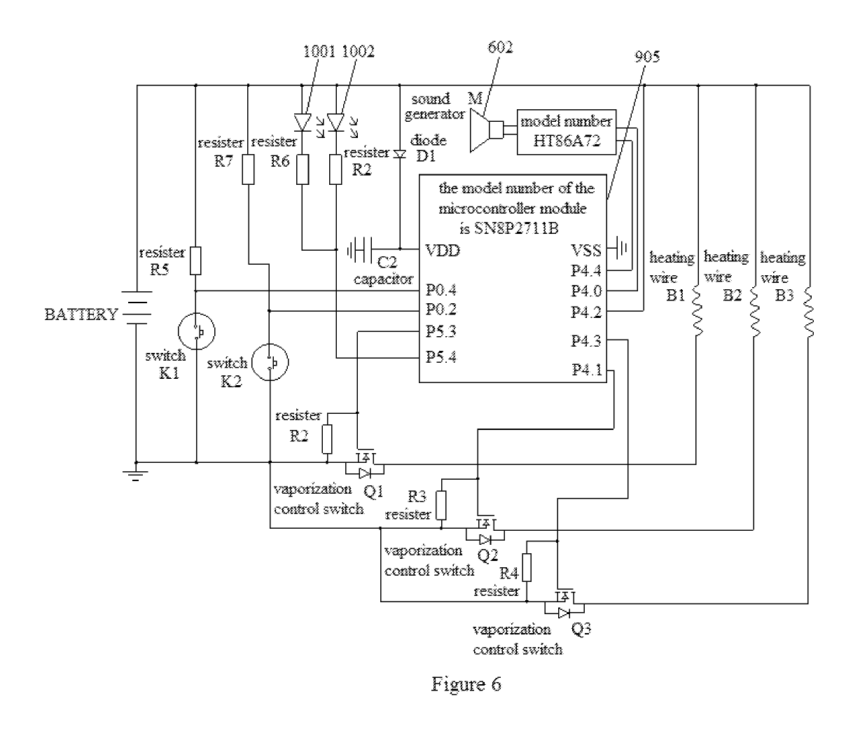

The microcontroller module 905 controls the first light-emitting element 1001 (as shown in FIG. 6), which is configured to simulate a smoking scene, to emit light with intensity gradually increasing with the intake of the smoke.

When sensing an action of the user to take in a fourth flow of smoke, the airflow-sensitive switch 902 generates the first trigger signal to turn on the vaporization control switch Q1, that is, the above procedure is repeated.

As can be seen from this specific application scenario, the microcontroller module may control, according to smoking actions of the user, different heating wires to vaporize electronic cigarette oil with different flavors, so that all of the heating wires in the heating wire assembly vaporize electronic cigarette oil cyclically. Thus, the user may take in smoke with different flavors cyclically, thereby improving user experience. The user would not take in smoke with a single flavor during smoking, which makes sampling smokes convenient for the user.

In this embodiment, the microcontroller module turns on multiple vaporization control switches electrically connected thereto sequentially and cyclically in response to the trigger signal generated by the smoking switch module, so that multiple heating wires in the electronic cigarette vaporize electronic cigarette oil with different flavors sequentially and cyclically. Thus, the user may take in smoke with different flavors, which makes sampling smokes convenient for the user. In addition, upon the smoking action of the user, the heating wires are controlled automatically to vaporize the electronic cigarette oil without complicated settings by the user, thus the operation of the user is facilitated and user experience is improved.

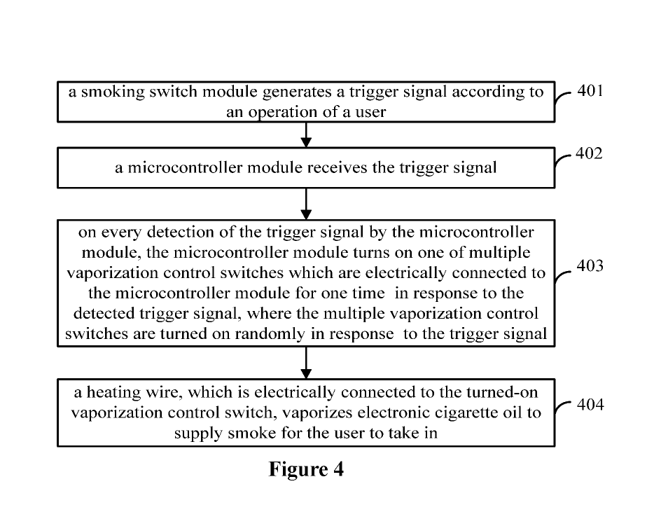

In a third embodiment, it is described in conjunction with FIG. 4 how the microcontroller module controls the multiple heating wires to vaporize the electronic cigarette oil randomly in response to the trigger signal.

In step 401, the smoking switch module generates the trigger signal according to an operation of a user.

In step 402, the microcontroller module receives the trigger signal.

The procedures of steps 401 to 402 are the same as the procedure of steps 201 to 202 described in the second embodiment, and the detailed description thereof is omitted.

In step 403, on every detection of the trigger signal by the microcontroller module, the microcontroller module turns on one of the multiple vaporization control switches which are electrically connected to the microcontroller module for one time in response to the detected trigger signal. The multiple vaporization control switches are turned on randomly in response to the trigger signal.

In this embodiment, on every detection of the trigger signal by the microcontroller module, the microcontroller module turns on one vaporization control switch, and the multiple vaporization control switches are turned on randomly.

In step 404, the heating wire, which is electrically connected to the turned-on vaporization control switch, vaporizes electronic cigarette oil to supply smoke for the user to take in.

Since the vaporization control switches are turned on randomly, heating wires which are electrically connected to the vaporization control switches respectively vaporize electronic cigarette oil randomly. That is, the order in which the heating wires vaporize electronic cigarette oil coincides with the order in which the vaporization control switches are turned on.

Since the multiple vaporization control switches are used for vaporizing electronic cigarette oil with different flavors, the user may take in smoke with different flavors.

It is to be noted that, the case where different heating wires are used for vaporizing electronic cigarette oil with different flavors in this embodiment is presented by way of illustration and not limitation. For example, if electronic cigarette oil with a certain flavor is preferred by the user, the number of heating wires for vaporizing the electronic cigarette oil with the certain flavor which is preferred by the user may be set to be larger than the number of heating wires for vaporizing electronic cigarette oil with other flavors. There is no limitation on the specific configuration.

For better understanding of the embodiment, the third embodiment is described in detail in the following in conjunction with a specific application scenario.

Reference is made to FIG. 3 again.

Vaporization control switches Q1, Q2 and Q3 are electrically connected to the microcontroller module 905.

The heating wire B1, which may be used for vaporizing mint-flavored electronic cigarette oil, is electrically connected to the vaporization control switch Q1.

The heating wire B2, which may be used for vaporizing strawberry-flavored electronic cigarette oil, is electrically connected to the vaporization control switch Q2.

The heating wire B3, which may be used for vaporizing coffee-flavored electronic cigarette oil, is electrically connected to the vaporization control switch Q3.

When sensing an action of the user to take in a first flow of smoke, the airflow-sensitive switch 902 generates a first trigger signal.

The microcontroller module 905 receives the first trigger signal and outputs a high-level signal in response to the first trigger signal to turn on the vaporization control switch Q2 randomly.

The battery electrically connected to the vaporization control switch Q2 powers the heating wire B2 to enable the heating wire B2 to vaporize the strawberry-flavored electronic cigarette oil.

As a result, the user may take in strawberry-flavored smoke.

When sensing an action of the user to take in a second flow of smoke, the airflow-sensitive switch 902 generates a second trigger signal.

The microcontroller module 905 receives the second trigger signal and outputs a high-level signal in response to the second trigger signal to turn on the vaporization control switch Q3 randomly.

The battery electrically connected to the vaporization control switch Q3 powers the heating wire B3 to enable the heating wire B3 to vaporize the coffee-flavored electronic cigarette oil.

As a result, the user may take in coffee-flavored smoke.

In this embodiment, the microcontroller module turns on the vaporization control switches randomly in response to the trigger signal, thereby making the smoking process more interesting for the user and further improving user smoking experience.

It is to be noted that, in the second embodiment, electronic cigarette oil with different flavors is vaporized sequentially and cyclically, while in the third embodiment, electronic cigarette oil with different flavors is vaporized randomly. In a specific application, the cyclical manner may be set by the manufacturer at the factory. In this case, when the user smokes, the electronic cigarette may automatically vaporize electronic cigarette oil with different flavors stored therein sequentially and cyclically. Alternatively, the cyclical manner may be set by the user. There is no limitation on the specific setting manner. For example, the microcontroller module may provide a selection menu for user to select the cyclical manner, and the user may performs the settings by means of a touch screen or a push key of the electronic cigarette. In this case, the user may select the cyclical manner of the multiple heating wires of the electronic cigarette according to his/her own requirements.

It is to be noted that, the vaporization manners described in the second embodiment and the third embodiment are only examples. There is no limitation on the specific vaporization order, and other cyclical manners may be adopted.

In the second embodiment and the third embodiment, the manners in which the microcontroller module controls the heating wires to vaporize electronic cigarette oil is preset, the microcontroller module automatically control the heating wire to vaporize corresponding electronic cigarette oil when sensing the trigger signal. In the following, reference is made to a fourth embodiment. In the fourth embodiment, it is described how the microcontroller module controls the manner in which the heating wires vaporize electronic cigarette oil according to a control instruction inputted by the user by means of a setting switch.

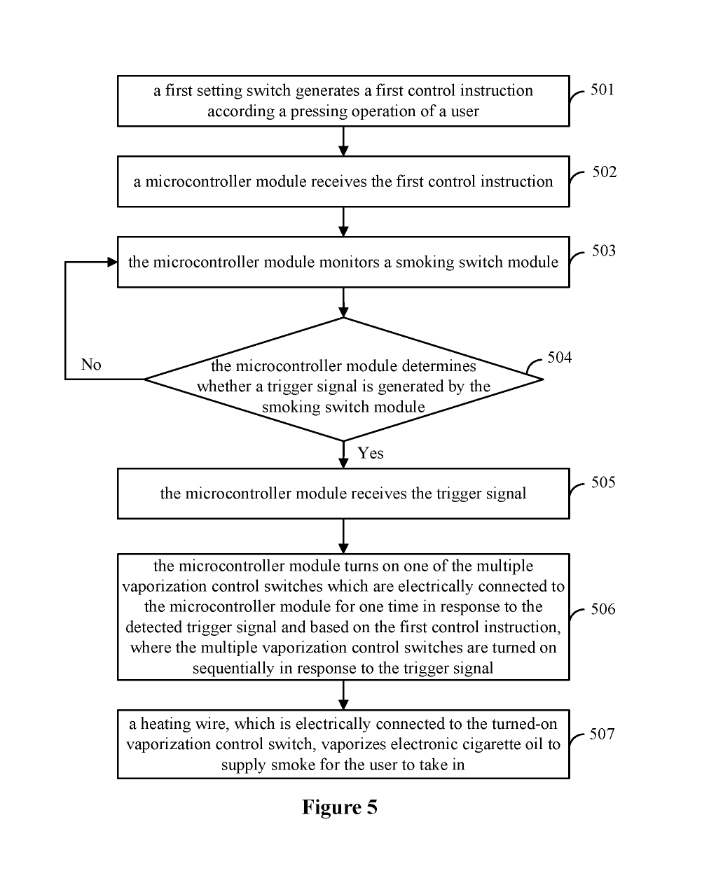

It is described in conjunction with FIG. 5 how the microcontroller module controls the heating wires to vaporize the electronic cigarette oil with different flavors sequentially according to a first control instruction.

In step 501, a first setting switch generates a first control instruction according to a pressing operation of the user.

The first setting switch is electrically connected to the microcontroller module and provided on an electronic cigarette body.

When a user presses the first setting switch, the first setting switch may generate the first control instruction according to the pressing operation of the user.

The first control instruction controls the microcontroller module to control the heating wires to vaporize electronic cigarette oil with different flavors sequentially.

In step 502, the microcontroller module receives the first control instruction.

In step 503, the microcontroller module monitors the smoking switch module.

The microcontroller module determines whether a trigger signal is generated by the smoking switch module according to the smoking action of the user.

In step 504, the microcontroller module determines whether the trigger signal is generated by the smoking switch module. In a case of positive determination, the process proceeds to step 505; and in a case of negative determination, the process returns to step 503.

If it is determined by the microcontroller module that the trigger signal is generated by the smoking switch module, it indicates that the user wishes to take in the vaporized smoke, and the process proceeds to step 505.

If it is determined by the microcontroller module that no trigger signal is generated by the smoking switch module, the process returns to step 503, where the microcontroller module continues to monitor the smoking switch module.

In step 505, the microcontroller module receives the trigger signal.

In step 506, the microcontroller module turns on one of the multiple vaporization control switches which are electrically connected to the microcontroller module for one time in response to the detected trigger signal and based on the first control instruction, where the multiple vaporization control switches are turned on sequentially in response to the trigger signal.

The first control instruction is received by the microcontroller module in advance, so that the microcontroller module determines, according to the first control instruction, that the user wishes the electronic cigarette oil with different flavors stored in the electronic cigarette to be vaporized sequentially and cyclically.

Therefore, on every detection of the trigger signal by the microcontroller module, the microcontroller module turns on one of the multiple vaporization control switches which are electrically connected to the microcontroller module in response to the detected trigger signal.

If the trigger signal is detected again, the microcontroller module turns on a next vaporization control switch. That is, the multiple vaporization control switches which are electrically connected to the microcontroller module are turned on sequentially.

For the manner in which the microcontroller module turns on the vaporization control switches sequentially in response to the trigger signal, reference may be made to step 203 described in the second embodiment, and the detailed description thereof is omitted in this embodiment.

In step 507, the heating wire, which is electrically connected to the turned-on vaporization control switch, vaporizes electronic cigarette oil to supply smoke for the user to take in.

The procedure of step 507 in this embodiment is the same as the procedure of step 204 described in the second embodiment, and the detailed description thereof is omitted.

In the following, it is described in further detail in conjunction with a specific application scenario how the microcontroller module controls the heating wires to vaporize the electronic cigarette oil with different favors sequentially according to the first control instruction.

Referring to FIG. 6, a first setting switch is provided on the electronic cigarette body and is electrically connected to the microcontroller module.

In this application scenario, a setting switch K1 is provided. Preferably, the setting switch is a first setting switch K1 configured to enable the user to take in smoke with different flavors cyclically and sequentially.

In using the electronic cigarette, if the user wishes to take in smoke with different flavors cyclically and sequentially, the user may press the first setting switch K1.

On reception of the press operation of the user, the first setting switch K1 generates the first control instruction.

On reception of the first control instruction, the microcontroller module 905 determines whether a trigger signal generated by the smoking switch module according to an operation of a user is received.

In this application scenario, the smoking switch module is a push-key switch K2 configured to receive a pressing operation of the user and generate the trigger signal according to the received pressing operation of the user.

In this application scenario, the microcontroller module 905 determines whether a trigger signal generated by the push-key switch K2 according to an operation of a user is received.

On reception of a first pressing operation of the user, the push-key switch K2 generates a first trigger signal according to the first pressing operation.

The microcontroller module 905 receives the first trigger signal and outputs a high-level signal in response to the first trigger signal to turn on the vaporization control switch Q1.

The battery electrically connected to the vaporization control switch Q1 powers the heating wire B1 to enable the heating wire B1 to vaporize the mint-flavored electronic cigarette oil.

As a result, the user may take in mint-flavored smoke.

On reception of a second pressing operation of the user, the push-key switch K2 generates a second trigger signal according to the second pressing operation.

The microcontroller module 905 receives the second trigger signal and outputs a high-level signal in response to the second trigger signal to turn on the vaporization control switch Q2.

The battery electrically connected to the vaporization control switch Q2 powers the heating wire B2 to enable the heating wire B2 to vaporize the strawberry-flavored electronic cigarette oil.

On reception of a third pressing operation of the user, the push-key switch K2 generates a third trigger signal according to the third pressing operation.

The microcontroller module 905 receives the third trigger signal and outputs a high-level signal in response to the third trigger signal to turn on the vaporization control switch Q3.

The battery electrically connected to the vaporization control switch Q3 powers the heating wire B3 to enable the heating wire B3 to vaporize the coffee-flavored electronic cigarette oil.

As a result, the user may take in mint-flavored smoke, strawberry-flavored smoke and coffee-flavored smoke cyclically.

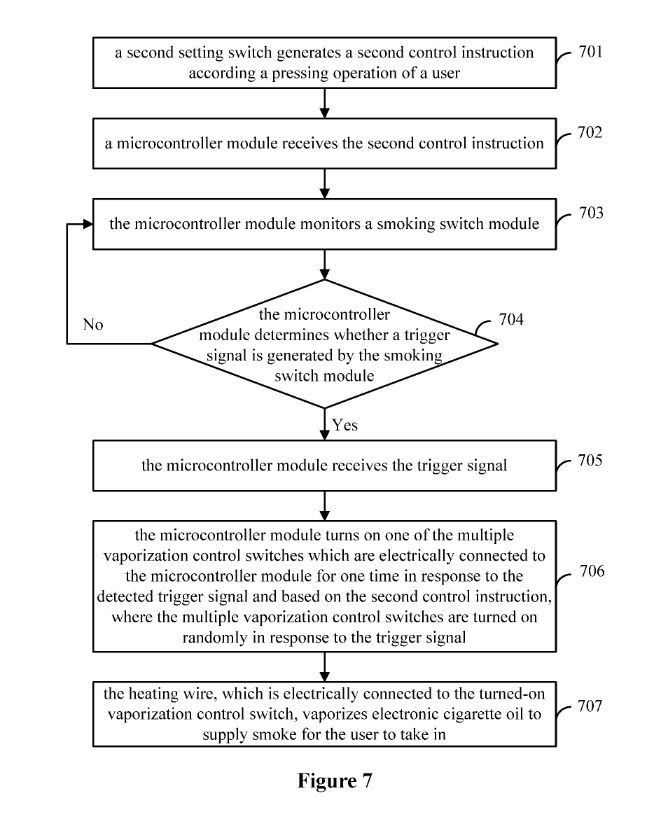

In the following, it is described in conjunction with FIG. 7 how the microcontroller module controls the heating wires to vaporize the electronic cigarette oil with different flavors randomly according to the second control instruction.

In step 701, a second setting switch generates a second control instruction according to a pressing operation of the user.

The second setting switch is electrically connected to the microcontroller module and is provided on the electronic cigarette body.

When being pressed by the user, the second setting switch may generate the second control instruction according to the pressing operation of the user.

The second control instruction controls the microcontroller module to control the heating wires to vaporize electronic cigarette oil with different flavors randomly, thereby making the smoking process more interesting for the user.

In step 702, the microcontroller module receives the second control instruction.

In step 703, the microcontroller module monitors the smoking switch module.

The microcontroller module determines whether a trigger signal is generated by the smoking switch module according to the smoking action of the user.

In step 704, the microcontroller module determines whether the trigger signal is generated by the smoking switch module. In a case of positive determination, the process proceeds to step 705; and in a case of negative determination, the process returns to step 703.

If it is determined by the microcontroller module that the trigger signal is generated by the smoking switch module, it indicates that the user wishes to take in the vaporized smoke, and the process proceeds to step 705.

If it is determined by the microcontroller module that no trigger signal is generated by the smoking switch module, the process returns to step 703, where the microcontroller module continues to monitor the smoking switch module.

In step 705, the microcontroller module receives the trigger signal.

In step 706, the microcontroller module turns on one of the multiple vaporization control switches which are electrically connected to the microcontroller module for one time in response to the detected trigger signal and based on the second control instruction, where the multiple vaporization control switches are turned on randomly in response to the trigger signal.

The second control instruction is received by the microcontroller module in advance, so that it is determined by the microcontroller module that the user wishes the electronic cigarette oil with different favors stored in the electronic cigarette to be vaporized randomly.

Therefore, on every detection of the trigger signal by the microcontroller module, the microcontroller module turns on one of the vaporization control switches which are electrically connected to the microcontroller module in response to the detected trigger signal.

If the trigger signal is detected again, the microcontroller module randomly turns on another vaporization control switch. That is, the multiple vaporization control switches which are electrically connected to the microcontroller module are turned on randomly.

For the manner in which the microcontroller module turns on the vaporization control switches randomly in response to the trigger signal, reference may be made to step 403 described in the third embodiment, and the detailed description thereof is omitted in this embodiment.

In step 707, the heating wire, which is electrically connected to the turned-on vaporization control switch, vaporizes electronic cigarette oil to supply smoke for the user to take in.

The procedure of step 707 in this embodiment is the same as the procedure of step 404 described in the third embodiment, and the detailed description thereof is omitted.

In the following, it is described in further detail in conjunction with a specific application scenario how the microcontroller module controls the heating wires to vaporize the electronic cigarette oil with different favors randomly according to the second control instruction.

Reference is made to FIG. 6 again. In this application scenario, a second setting switch is provided on the electronic cigarette body and is electrically connected to the microcontroller module.

In this application scenario, the second setting switch is denoted as K1.

The second setting switch K1 is electrically connected to the microcontroller module 905.

In using the electronic cigarette, if the user wishes to take in smoke with different flavors randomly, the user may press the second setting switch K1.

On reception of the press operation of the user, the second setting switch K1 generates the second control instruction.

On reception of the second control instruction, the microcontroller module 905 determines whether a trigger signal generated by a smoking switch module according to an operation of a user is received.

In this application scenario, the smoking switch module is the push-key switch K2 configured to receive a pressing operation of the user and generate the trigger signal according to the received pressing operation of the user.

On reception of a first pressing operation of the user, the push-key switch K2 generates a first trigger signal according to the first pressing operation.

The microcontroller module 905 receives the first trigger signal and outputs a high-level signal in response to the first trigger signal to turn on the vaporization control switch Q3.

The battery electrically connected to the vaporization control switch Q3 powers the heating wire B3 to enable the heating wire B3 to vaporize the coffee-flavored electronic cigarette oil.

On reception of a second pressing operation of the user, the push-key switch K2 generates a second trigger signal according to the second pressing operation.

The microcontroller module 905 receives the second trigger signal and outputs a high-level signal in response to the second trigger signal to turn on the vaporization control switch Q2.

The battery electrically connected to the vaporization control switch Q2 powers the heating wire B2 to enable the heating wire B2 to vaporize the strawberry-flavored electronic cigarette oil.

As a result, the user may take in mint-flavored smoke, strawberry-flavored smoke and coffee-flavored smoke randomly.

In this embodiment, the user may take in electronic cigarette oil with different flavors randomly, thereby making the smoking process more interesting for the user.

In a specific application of this embodiment, both the first push-key switch and the second push-key switch may be provided on the electronic cigarette body. In another embodiment, only one of the first push-key switch and the second push-key switch may be provided on the electronic cigarette body. For the electrical connection relationship between the first push-key switch and the microcontroller module and between the second push-key switch and the microcontroller module, reference may be made to the electrical connection relationship between K1 and the microcontroller module 905 shown in FIG. 6. In FIG. 6, the description is given by taking a single K1 as an example. In another embodiment, multiple K1s may be provided for implementing different cyclical manners according to different requirements, as long as the multiple K1s are electrically connected to the microcontroller module 905.

In this embodiment, the user may press the first setting switch K1 or the second setting switch K1 to enable the microcontroller module to control the manner in which the heating wires vaporize electronic cigarette oil, thus the user can select the manner in which the electronic cigarette oil is vaporized in a customized manner, thereby enhancing the degree of user participation and enabling the electronic cigarette to meet the requirement of the user for sampling smokes.

In a fifth embodiment, in a case that the user smokes in the manner described in the first embodiment, the second embodiment, the third embodiment or the fourth embodiment, if the user tastes and determines that current vaporized smoke is preferred by the user, the user in this embodiment may enable the electronic cigarette to stop vaporizing electronic cigarette oil with other flavors.

Particularly, the fifth embodiment is described in combination with the second embodiment. It is to be noted that, the procedure where the fifth embodiment is implemented in combination with other embodiments is the same, and the description thereof is omitted. However, the fifth embodiment in combination with other embodiments to achieve the technical solution of the electronic cigarette continuing vaporizing the current vaporized electronic cigarette oil with a certain flavor still falls within the scope of protection of the disclosure.

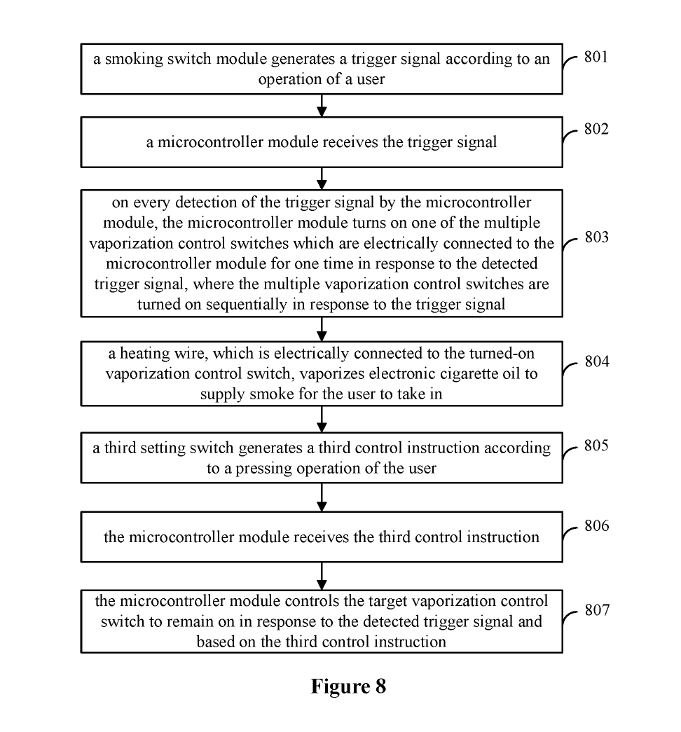

This embodiment is described in detail in conjunction with FIG. 8.

In step 801, the smoking switch module generates a trigger signal according to an operation of a user.

In step 802, the microcontroller module receives the trigger signal.

The procedures of steps 801 to 802 in this embodiment are the same as the procedures of steps 201 to 202 described in the second embodiment respectively, and the detailed description thereof is omitted.

In step 803, on every detection of the trigger signal by the microcontroller module, the microcontroller module turns on one of the multiple vaporization control switches which are electrically connected to the microcontroller module for one time in response to the detected trigger signal. The multiple vaporization control switches are turned on sequentially in response to the trigger signal.

In this embodiment, the microcontroller module determines the turned-on vaporization control switch as a target vaporization control switch.

In step 804, the heating wire, which is electrically connected to the turned-on vaporization control switch, vaporizes electronic cigarette oil to supply smoke for the user to take in.

In step 805, a third setting switch generates a third control instruction according to a pressing operation of the user.

The third setting switch is electrically connected to the microcontroller module.

The third setting switch is provided on the electronic cigarette body.

When being pressed by the user, the third setting switch may generate the third control instruction according to the pressing operation of the user.

In step 806, the microcontroller module receives the third control instruction.

In step 807, the microcontroller module controls the target vaporization control switch to remain on in response to the detected trigger signal and based on the third control instruction.

If it is determined by the microcontroller module that the trigger signal generated by the smoking switch module is received, the microcontroller module controls the target vaporization control switch to remain on, so that the electronic cigarette does not vaporize electronic cigarette oil with other flavors sequentially or randomly. Thus, the user may take in the electronic cigarette oil with the flavor which is vaporized by the heating wire electrically connected to the target vaporization control switch, thereby further improving user experience.

In the following, the fifth embodiment is described in further detail in conjunction with a specific application scenario.

Reference is made to FIG. 6 again. The third setting switch is denoted as K1 in FIG. 6.

The description is given in combination with the specific application scenario described in the second embodiment, the third embodiment and the fourth embodiment.

In the specific application scenarios described in the second embodiment, the third embodiment and the fourth embodiment, the user takes in smoke with different flavors sequentially or randomly.

For the specific procedure, reference may be made to the specific application scenarios described in the second embodiment, the third embodiment and the fourth embodiment, and the detailed description thereof is omitted in this application scenario.

In this application scenario, the microcontroller module determines one of the multiple vaporization control switches which is turned on latest as the target vaporization control switch.

During the smoking process, if the user feels that the smoke currently taken in tastes good, and wishes to continue taking the smoke with the current flavor and not to switch to other flavors, the user may press the third setting switch K1 provided on the electronic cigarette body.

The third setting switch K1 generates the third control instruction according to the operation of the user.

The microcontroller module 905 receives the third control instruction, and controls the target vaporization control switch to remain on, so that the vaporization control switch module is stopped from turning on sequentially or randomly, and the heating wire electrically connected to the target vaporization control switch continues vaporizing the electronic cigarette oil.

For example, when taking in smoke with different flavors sequentially or randomly, if the user feels that the mint-flavored smoke currently taken in suits his/her taste, the user may press the third setting switch K1, so that the heating wire configured to vaporize the mint-flavored electronic cigarette oil continues vaporizing this electronic cigarette oil when the user continues smoking, and the heating wires configured to vaporize the electronic cigarette oil with other flavors does not operate any more.

The user may press the third setting switch again if he or she wishes the electronic cigarette oil to be vaporized sequentially or randomly all over again.

In a sixth embodiment, the user may be aware of the flavor of the smoke which is currently vaporized by the heating wire at any time during smoking.

In order to enable the user may be aware of the flavor of the smoke currently taken in at any time during smoking, the microcontroller module may prompt to the user the flavor of the electronic cigarette oil vaporized by the heating wire electrically connected to the turned-on vaporization control switch.

The sixth embodiment may be implemented in combination with any one of the first embodiment to the fifth embodiment. That is, with the procedure of any one of the first embodiment to the fifth embodiment is performed, one of the multiple vaporization control switches in the electronic cigarette is turned on, so that the heating wire electrically connected to the turned-on vaporization control switch vaporizes electronic cigarette oil with a certain flavor. For the specific procedure, reference may be made to the first embodiment to the fifth embodiment, and the detailed description thereof is omitted in this embodiment.

In the sixth embodiment, the microcontroller module determines and stores the flavor of the electronic cigarette oil to be vaporized by each of the heating wires in the electronic cigarette in advance. Thus, if the microcontroller module determines the heating wire electrically connected to the turned-on vaporization control switch, the microcontroller module is enabled to determine the flavor of the electronic cigarette oil vaporized by the heating wire.

The microcontroller module determines a target flavor of the electronic cigarette oil vaporized by the heating wire electrically connected to the turned-on vaporization control switch.

The microcontroller module prompts to the user the target flavor, to enable the user to determine the specific flavor of the smoke which is currently taken in.

The microcontroller module may prompts to the user in the following two manners.

In the following, a first manner is described.

A display screen is electrically connected to the microcontroller module 905.

The display screen is configured to prompt to the user the flavor of the electronic cigarette oil vaporized by the heating wire electrically connected to the turned-on vaporization control switch in a form of text.

The microcontroller module 905 provides the target flavor in a form of text by means of the display screen.

The user may determine the flavor of the currently vaporized smoke through the display screen.

For a second manner, reference may be made to the circuit connection structure shown in FIG. 6.

A sound generator 602 is electrically connected to the microcontroller module 905.

The sound generator 602 is electrically connected to the microcontroller module 905.

The microcontroller module 905 provides the target flavor in a form of voice by means of the sound generator 602.

As shown in FIG. 6, the microcontroller module 905 includes a MCU chip having a voice circuit, and is configured to output an analog signal by means of the MCU chip having the voice circuit, in order to enable the sound generator 602 to make a sound for prompting to the user the target flavor.

Preferably, the MCU chip having the voice circuit is the one with a model number of HTB6A72.

In this embodiment, the microcontroller module prompts to the user, by means of the sound generator and/or the display screen, the flavor of the electronic cigarette oil vaporized by the heating wire which currently vaporizes the electronic cigarette oil, in order that the user may be aware of the flavor of the smoke currently taken in at any time during smoking, thereby making sampling smokes convenient for the user and providing a convenience to the user.

In the first to sixth embodiments, the electronic cigarette oil vaporization method is described in detail. In a seventh embodiment, an electronic cigarette control circuit for implementing the method according to first to sixth embodiments is described in detail.

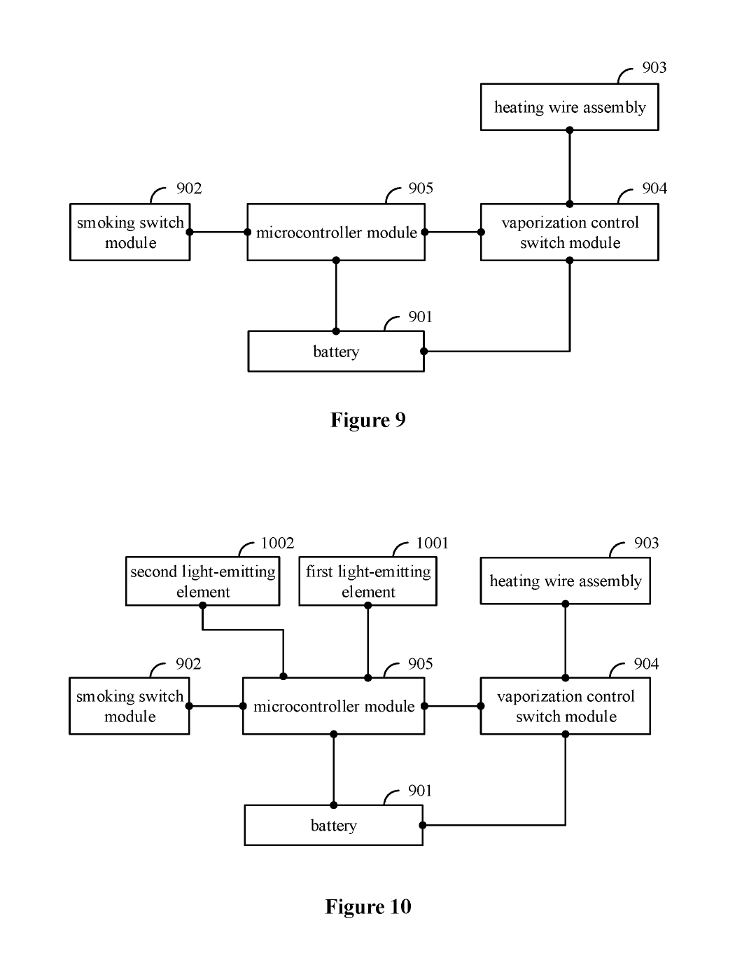

Referring to FIG. 9, the electronic cigarette control circuit includes a battery 901, the smoking switch module 902 configured to generate the trigger signal according to an operation of a user, a heating wire assembly 903, a vaporization control switch module 904 and the microcontroller module 905.

Particularly, the battery 901 is configured to store electrical energy, and power the microcontroller module 905 and the heating wire assembly 903.

The smoking switch module 902 is configured to generate the trigger signal according to an operation of a user. The trigger signal is used for enabling the microcontroller module 905 to turn on a corresponding vaporization control switch in the vaporization control switch module 904.

The heating wire assembly 903 includes the multiple heating wires configured to vaporize electronic cigarette oil to generate smoke. In this embodiment, in order that the user can take in smoke with different flavors, different heating wires in the heating wire assembly 903 are configured to vaporize electronic cigarette oil with different flavors. However, it is to be noted that, this configuration is only an example, other configurations, such as a implementation where different heating wires are configured to vaporize same electronic cigarette oil, may be adopted in order to extend usage time of electronic cigarette oil in the electronic cigarette.

The vaporization control switch module 904 includes multiple vaporization control switches electrically connected to the heating wires and the battery 901 respectively.

The vaporization control switches are turned on under control of the microcontroller module 905. That is, the microcontroller module 905 turns on one of the multiple vaporization control switches which are electrically connected to the microcontroller module in response to the trigger signal. Reference may be made to the first embodiment for the detailed description, which is omitted in this embodiment.

If the vaporization control switch is turned on, the battery 901 electrically connected to the turned-on vaporization control switch is enabled to power the heating wire electrically connected to the turned-on vaporization control switch, so that the heating wire vaporizes electronic cigarette oil using the power supplied by the battery 901, in order to generate smoke.

The microcontroller module 905 provided according to this embodiment is electrically connected to the battery 901, the smoking switch module 902 and the vaporization control switch module 904 respectively.

In this embodiment, in a case of detecting that the trigger signal is generated by the smoking switch module 902, the microcontroller module 905 turns on a corresponding vaporization control switch; and the heating wire electrically connected to the turned-on vaporization control switch vaporizes the electronic cigarette oil to supply smoke for the user to take in. Since in this embodiment, the vaporization control switch is turned on under control of the microcontroller module 905, it may be implemented that the electronic cigarette is capable of vaporizing electronic cigarette with various flavors, thereby making sampling smokes convenient for the user. Further, the operation of the corresponding heating wire is controlled by the microcontroller module 905, thereby eliminating the need for a complicated adjustment mechanism, thus the operation process is simple and easy to be handled by the user.

In an eighth embodiment, a specific structure of the electronic cigarette control circuit is described in detail in conjunction with FIG. 10.

For the specific connection structures and functions of the battery 901, the heating wire assembly 903, the vaporization control switch module 904 and the microcontroller module 905 shown in FIG. 10, reference may be made to FIG. 9, and the description thereof is omitted here.

The vaporization control switch module may be a relay, a field effect transistor, or a triode, and this is not intended to limiting.

In this embodiment, the smoking switch module 902 configured to generate the trigger signal may have the following two structures.

In a first instance, the smoking switch module 902 may be an airflow-sensitive switch configured to generate the trigger signal according to a smoking action of the user.

The trigger signal is generated in the following manner.

When the user smokes the electronic cigarette, a pressure in a flow passage in the electronic cigarette for the smoke to flow through is reduced. The airflow-sensitive switch senses the pressure reduction in the smoke passage and generates the trigger signal.

A specific structure and circuit connection relationship of the airflow-sensitive switch are shown in FIG. 3. As shown in FIG. 3, the smoking switch module 902 is the airflow-sensitive switch. Preferably, an airflow-sensitive switch integrated with a control module, of which the model number is S087, may be employed as the airflow-sensitive switch. Of course, this airflow-sensitive switch is only an example, and this is not intended to limiting.

In a second instance, the smoking switch module 902 may be a push-key switch configured to receive a pressing operation of the user and generate the trigger signal according to the received pressing operation.

For a specific circuit connection relationship of the push-key switch, reference may be made to the push-key switch K2 shown in FIG. 6.

The push-key switch is provided on an outer surface of the electronic cigarette body. The user presses the push-key switch when he or she wishes to take in the smoke. The push-key switch may generate the trigger signal according to the pressing operation of the user.

In this embodiment, there is no limitation on the manner in which the trigger signal is generated. In this embodiment, the description is given by taking the airflow-sensitive switch serving as the smoking switch module 902 as an example.

In order to improve user smoking experience, in this embodiment, a first light-emitting element 1001 is electrically connected to the microcontroller module 905 and configured to simulate a smoking scene.

On reception of a sensing signal generated by the airflow-sensitive switch, the microcontroller module 905 may control the first light-emitting element 1001 to emit light.

In this embodiment, the first light-emitting element 1001 emits light for simulating a smoking scene.

The microcontroller module 905 gradually increases the current flowing through the first light-emitting element 1001, so that the first light-emitting element 1001 emits light with intensity gradually increasing with the intake of the smoke.

The pattern of the light emitted by the first light-emitting element 1001 in this embodiment is only an example. In another embodiment, the first light-emitting element 1001 may emit light in other patterns, for example, light which is constantly on, light flashing on and off at a rate or the like. There is no limitation on the specific light pattern in this embodiment.

Reference may be made to FIG. 6 for the specific circuit connection relationship of the first light-emitting element 1001.

Particularly, a second light-emitting element 1002 may be electrically connected to the microcontroller module 905.

On detection of the trigger signal generated by the smoking switch module 902, the microcontroller module 905 controls the second light-emitting element 1002 to emit light, and based on the light emitted by the second light-emitting element 1002, the user determines the operation condition of the electronic cigarette.

The pattern of the light emitted by the second light-emitting element 1002 is not limited thereto, which may include intensity gradually increasing with the intake of the smoke, constantly on, flashing on and off at a rate or the like.

It is to be noted that, the light-emitting element electrically connected to the microcontroller module 905 may be configured to indicate other functions. For example, the light-emitting element emits light to alert the user in a case that a volume of the electronic cigarette oil in an electronic cigarette oil bottle for storing the electronic cigarette oil is lower than a certain level, or in a case that the battery power is lower than a certain level, and the like. There is no limitation on the specific function indicated by the light-emitting element in this embodiment.

The light-emitting element may be an LED lamp.

In this embodiment, as shown in FIG. 3 and FIG. 6, the microcontroller module 905 is the one with a model number of SN8P2711B, which is only an example and not limiting. In practice, the microcontroller module 905 with other part numbers may be employed.

Reference is made to FIG. 3 again. A capacitor C2 is electrically connected to the microcontroller module 905 and configured to power the microcontroller module 905 in a case that the heating wire is shorted, in order to avoid a condition where the control circuit of the electronic cigarette cannot operate normally when the heating wire B1, B2 or B3 in the heating wire assembly is shorted, thereby allowing a buffering time period for the microcontroller module 905 to turn off the vaporization control switch module 904, and avoiding dangerous conditions.

Reference may be made to the first to third embodiments for the manners how the microcontroller module 905 controls the heating wires to vaporize electronic cigarette oil with different flavors sequentially or randomly, and the detailed description thereof is omitted in this embodiment.

In this embodiment, in order to improve user smoking experience, the light-emitting element is electrically connected to the microcontroller module 905, thus the electronic cigarette may emit light with intensity gradually increasing with the intake of the smoke when the user is smoking, in order to simulate a smoking scene. In addition, the light-emitting element may be configured to indicate the electronic cigarette oil volume of the electronic cigarette, the battery power and the like according to the needs of the user, thus the user may be aware of the operation condition of the electronic cigarette at any time, thereby further improving convenience for the user.

In a ninth embodiment, a specific circuit connection structure of the electronic cigarette control circuit including a setting switch is described in detail.

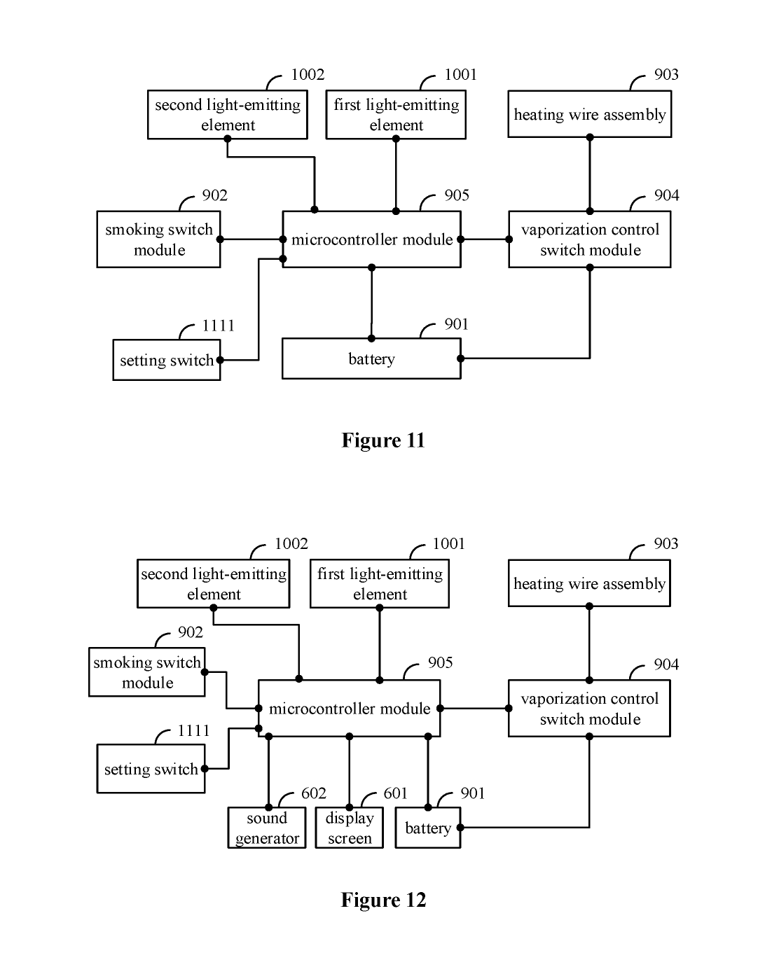

Reference is made to FIG. 11. For the specific functions and connection structures of the battery 901, the heating wire assembly 1003, the vaporization control switch module 1004, the microcontroller module 905, the smoking switch module 902, the first light-emitting element 1001 and the second light-emitting element 1002 included in the electronic cigarette control circuit shown in FIG. 11, reference may be made to FIG. 10, and the detailed description thereof is omitted in this embodiment.

In this embodiment, a setting switch 1111 is electrically connected to the microcontroller module 905. The user may control the heating wires of the electronic cigarette to vaporize electronic cigarette oil with different flavors by means of the setting switch 1111. Thus, the user may take in smoke with different flavors, thereby improving user smoking experience.

The specific structure of the circuit in which the setting switch 1111 is connected is shown in FIG. 6.

The setting switch 1111 in this embodiment is the switch K1 shown in FIG. 6.

In addition, in this embodiment, electronic cigarette oil with different flavors is stored in the electronic cigarette, and each heating wire is configured to vaporize the electronic cigarette oil with a single flavor.

As shown in FIG. 6, vaporization control switches Q1, Q2 and Q3 are electrically connected to the microcontroller module 905.

The heating wire B1, which may be used for vaporizing mint-flavored electronic cigarette oil, is electrically connected to the vaporization control switch Q1.

The heating wire B2, which may be used for vaporizing strawberry-flavored electronic cigarette oil, is electrically connected to the vaporization control switch Q2.

The heating wire B3, which may be used for vaporizing coffee-flavored electronic cigarette oil, is electrically connected to the vaporization control switch Q3.

In this embodiment, the specific flavor of the electronic cigarette oil is not meant to limiting, which may be other flavors such as tobacco.

As compared to the above embodiment where the microcontroller module 905 automatically turns on the vaporization control switches, in this embodiment, the user may adjust the manner in which the microcontroller module 905 turns on the vaporization control switches by means of the setting switch 1111 at any time according to his or her own needs.

The vaporization of the heating wires may be controlled by means of the setting switch 1111 in the following manners.

In a first manner, the setting switch 1111 is the first setting switch configured to enable the microcontroller module 905 to turn on the multiple vaporization control switches sequentially.

The first setting switch is provided on the electronic cigarette body and electrically connected to the microcontroller module 905.

In using the electronic cigarette, if the user wishes to take in smoke with different flavors cyclically, the user may press the first setting switch.

The first setting switch is the switch K1 shown in FIG. 6.

On reception of the pressing operation of the user, the first setting switch generates a first control instruction.

The microcontroller module 905 receives the first control instruction, and turns on the vaporization control switches Q1, Q2 and Q3 sequentially and cyclically according to the first control instruction.

Reference may be made to the fourth embodiment for the detailed description, which is omitted in this embodiment.

In a second manner, the setting switch 1111 is the second setting switch configured to enable the microcontroller module 905 to turn on the multiple vaporization control switches randomly.

The second setting switch is the switch K1 shown in FIG. 6.

In using the electronic cigarette, if the user wishes to take in smoke with different flavors randomly, the user may press the second setting switch.

On reception of the pressing operation of the user, the second setting switch generates a second control instruction.

The microcontroller module 905 receives the second control instruction, and turns on the vaporization control switches Q1, Q2 and Q3 randomly according to the second control instruction.

Reference may be made to the fourth embodiment for the detailed description, which is omitted in this embodiment.

In a third manner, the setting switch 1111 is the third setting switch configured to enable the microcontroller module 905 to control the target vaporization control switch to remain on.

The third setting switch is the switch K1 shown in FIG. 6.

In using the electronic cigarette, if the user does want to switch to another flavor and wishes to continue taking in smoke currently vaporized by the heating wire, the user may press the third setting switch.

The third setting switch generates a third control instruction according to the operation of the user.

The microcontroller module 905 receives the third control instruction, and control the vaporization control switch which is currently turned on to remain on, thus the vaporization control switch module 1104 stops being turned on cyclically or randomly, and the heating wire electrically connected to the vaporization control switch which is currently turned on continues vaporizing the electronic cigarette oil.

Reference may be made to the fifth embodiment for the detailed description, which is omitted in this embodiment.

A setting switch for implementing the above functions may be provided on the electronic cigarette body by the manufacturer according to different settings and purposes. There is no limitation on the specific number of the setting switches in this embodiment.

Reference is made to FIG. 12, in which a specific structure of the electronic cigarette control circuit is described in further detail.

A display screen 601 is electrically connected to the microcontroller module 905 and configured to prompt to the user the flavor of the electronic cigarette oil vaporized by the heating wire electrically connected to the turned-on vaporization control switch in a form of text; and/or a sound generator 602 is electrically connected to the microcontroller module 905 and configured to prompt to the user the flavor of the electronic cigarette oil vaporized by the heating wire electrically connected to the turned-on vaporization control switch in a form of voice.

In this embodiment, the setting switch 1111 is electrically connected to the microcontroller module. By means of the setting switch 1111, the heating wires of the electronic cigarette may be enabled to vaporize the electronic cigarette oil cyclically or randomly, or the electronic cigarette oil with the flavor favored by the user may be selected and vaporized, thus the user may conveniently select the electronic cigarette oil with the flavor he or she likes, thereby further improving convenience for the user. In addition, the user may take in smoke with various flavors with one electronic cigarette, thereby making sampling smokes convenient for the user.

In this embodiment, the user may set the manner in which the electronic cigarette oil is vaporized in a customized manner by setting the setting switch electrically connected to the microcontroller module. The user may determine whether to vaporize the electronic cigarette oil sequentially or randomly by the heating wires, thereby improving user smoking experience, and providing a convenience to the user. Further, when sampling smokes, the user may be aware of the flavor of the electronic cigarette oil currently vaporized by the heating wire at any time, which makes sampling smoking more convenient for the user.

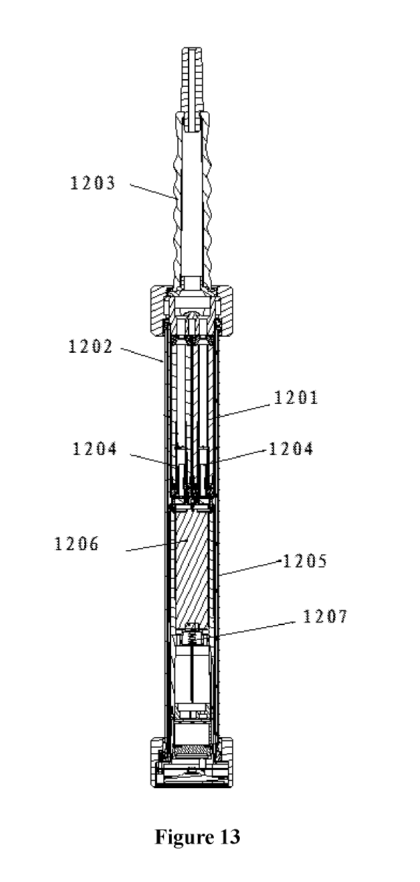

In a tenth embodiment, a specific structure of the electronic cigarette for implementing the method according to the above embodiments is described in detail in conjunction with FIG. 13.

As shown in FIG. 13, the electronic cigarette includes an electronic cigarette body.

In the electronic cigarette body, multiple electronic cigarette oil receiving volumes 1201 are provided for storing the electronic cigarette oil with different flavors.

In this embodiment, electronic cigarette oil with different flavors is stored in different electronic cigarette oil receiving volumes 1201. There is no limitation on the specific storage manner in this embodiment, so long as electronic cigarette oil with different flavors to be vaporized by different heating wires are stored in the electronic cigarette.

The electronic cigarette body is provided with a vaporizer 1202. An end of the vaporizer 1202 is extended to form a smoking end 1203 matching a shape of the mouth of the user. Alternatively, the vaporizer 1202 is integrated with the smoking end 1203.

In the vaporizer 1202, the multiple heating wires 1204 are provided for vaporizing electronic cigarette oil. Different heating wires 1204 are configured to vaporize electronic cigarette oil with different flavors. Thus, the user may take in smoke with different flavors by means of the electronic cigarette.

The electronic cigarette body further includes a battery rod assembly 1205 configured to power the vaporizer 1202.

The battery rod assembly 1205 is provided with the microcontroller module, the battery 1206, the smoking switch module 1207, and the vaporization control switches which are electrically connected to the heating wires 1204 and the battery 1206 respectively.

In this embodiment, in the electronic cigarette, the electronic cigarette control circuit described in the above embodiments is provided, which includes the battery 1206, the smoking switch module, the heating wire assembly, the vaporization control switch module the microcontroller module. Reference may be made to the above embodiments for the specific connection structure and the function of the electronic cigarette control circuit, and the detailed description thereof is omitted in this embodiment.

In this embodiment, since electronic cigarette oil with different flavors is stored in the electronic cigarette, and different heating wires vaporize electronic cigarette oil with different flavors. Thus, the user may take in smoke with different flavors. The user experience is improved and a convenience is provided to the user.

In an eleventh embodiment, it is described how the heating wires in the electronic cigarette vaporize electronic cigarette oil with different flavors.

In this embodiment, the electronic cigarette oil receiving volumes 1201 may be arranged in the following manners.

In a first manner, the electronic cigarette oil receiving volume 1201 is a first electronic cigarette oil bottle, and multiple first electronic cigarette oil bottles are connected to the vaporizer 1202 respectively.

The multiple heating wires in the vaporizer 1202 are configured to vaporize electronic cigarette oil in the multiple first electronic cigarette oil bottles respectively, that is, the multiple heating wires have a one-to-one correspondence with the multiple first electronic cigarette oil bottles, so that different heating wires vaporize electronic cigarette oil in different first electronic cigarette oil bottles.

The electronic cigarette body is provided with multiple first electronic cigarette oil bottles, and electronic cigarette oil with different flavors is stored in different first electronic cigarette oil bottles, in order that the electronic cigarette can vaporize electronic cigarette oil with different flavors.

The multiple first electronic cigarette oil bottles are transparent containers, and preferably are glass containers. Further, the glass container may be marked with scale or may be provided with an observation window, thus the user can be aware of the amount of the remaining electronic cigarette oil in each first electronic cigarette oil bottle at any time.

In a second manner, multiple electronic cigarette oil receiving volumes 1201 are provided in a second electronic cigarette oil bottle, the multiple electronic cigarette oil receiving volumes 1201 are isolated from each other in a sealed manner, and the second electronic cigarette oil bottle is connected to the vaporizer 1202, so that different heating wires vaporize electronic cigarette oil in different electronic cigarette oil receiving volumes 1201.

One second electronic cigarette oil bottle is provided in the electronic cigarette body, and multiple electronic cigarette oil receiving volumes 1201 are provided in the second electronic cigarette oil bottle. The multiple electronic cigarette oil receiving volumes 1201 are isolated from each other in a sealed manner. Thus, the electronic cigarette may store electronic cigarette oil with different flavors with a single electronic cigarette oil bottle.

The multiple electronic cigarette oil receiving volumes 1201 provided in the second electronic cigarette oil bottle are transparent, thus the user can observe the amount of the remaining electronic cigarette oil in the multiple electronic cigarette oil receiving volumes 1201 at any time.

In a third manner, multiple oil-absorbing cotton blocks are provided in the vaporizer 1202. The multiple oil-absorbing cotton blocks are isolated from each other and configured to supply electronic cigarette oil to the heating wires 1204 respectively, and each oil-absorbing cotton block is used as an electronic cigarette oil receiving volume 1201 for storing electronic cigarette oil with a single flavor. The electronic cigarette oil in the electronic cigarette oil receiving volume 1201 is delivered via an oil guiding wire to the heating wire 1204 for vaporization.

In this embodiment, the implementation where the battery rod assembly 1205 is provided at the end further away from the smoking end 1203 is only an example, and there is no limitation on the specific configuration of the electronic cigarette in this embodiment. For example, the battery rod assembly 1205 may also be provided at the end closer to the smoking end 1203, and the other end of the battery rod assembly 1205 is connected to the vaporizer. With this configuration, the user can be further prevented from taking in non-vaporized electronic cigarette oil, and may also be prevented from getting burnt.

Further, the battery rod assembly 1205 and the vaporizer 1202 in this embodiment are arranged coaxially. However, the battery rod assembly 1205 and the vaporizer 1202 may be arranged in parallel or in other arrangement, so long as the electronic cigarette includes multiple heating wires 1204 for vaporizing electronic cigarette oil with different flavors.

The specific installation and structure of the heating wires 1204 in the vaporizer is known in the conventional art, and the detailed description thereof is omitted. In addition, reference may be made to the above embodiments for the electrical connections between the heating wires 1204 and the microcontroller module and the battery 1206, and the description thereof is omitted here.

The installation manner of the battery 1206 in the battery rod assembly 1205 is known in the conventional art, and the detailed description thereof is omitted. In addition, reference may be made to the above embodiments for the electrical connections between the battery 1206 and the microcontroller module and the heating wires 1204, and the description thereof is omitted here.

As described above, the above embodiments are merely provided for describing the technical solutions of the present application, but are not intended to limit the present application. Although the present application is described in detail with reference to the foregoing embodiments, those skilled in the art should understand that, they can still modify technical solutions described in the foregoing embodiments, or make equivalent substitutions to a part of the technical features; and such modifications or substitutions do not enable the essence of corresponding technical solutions to depart from the spirit and scope of the technical solutions of the embodiments.

1. An electronic cigarette oil vaporization method, comprising:
generating, by a smoking switch module configured to generate a trigger signal according to an operation of a user, the trigger signal according to the operation of the user;
receiving, by a microcontroller module, the trigger signal;
turning on, by the microcontroller module, one of a plurality of vaporization control switches which are electrically connected to the microcontroller module in response to the trigger signal; and
vaporizing, by a heating wire among a plurality of heating wires which is electrically connected to the turned-on vaporization control switch, electronic cigarette oil to supply smoke for the user to take in, wherein the plurality of heating wires correspond to the plurality of vaporization control switches and a variety of electronic cigarette oil respectively.

2. The electronic cigarette oil vaporization method according to claim 1, wherein the turning on, by the microcontroller module, one of the plurality of vaporization control switches which are electrically connected to the microcontroller module in response to the trigger signal comprises:
on every detection of the trigger signal by the microcontroller module, turning on, by the microcontroller module, one of the plurality of vaporization control switches which are electrically connected to the microcontroller module for one time in response to the detected trigger signal, wherein the plurality of vaporization control switches are turned on sequentially in response to the trigger signal, or
on every detection of the trigger signal by the microcontroller module, turning on, by the microcontroller module, one of the plurality of vaporization control switches which are electrically connected to the microcontroller module for one time in response to the detected trigger signal, wherein the plurality of vaporization control switches are turned on randomly in response to the trigger signal.

3. The electronic cigarette oil vaporization method according to claim 1, further comprising:
generating, by a first setting switch electrically connected to the microcontroller module, a first control instruction according to a pressing operation of the user; and
receiving, by the microcontroller module, the first control instruction,
wherein the turning on, by the microcontroller module, one of the plurality of vaporization control switches which are electrically connected to the microcontroller module in response to the trigger signal comprises:
in a case that it is detected by the microcontroller module that the trigger signal generated by the smoking switch module is received by the microcontroller module, turning on, by the microcontroller module, one of the plurality of vaporization control switches which are electrically connected to the microcontroller module for one time in response to the detected trigger signal and based on the first control instruction, wherein the plurality of vaporization control switches are turned on sequentially in response to the trigger signal.

4. The electronic cigarette oil vaporization method according to claim 1, further comprising:
generating, by a second setting switch electrically connected to the microcontroller module, a second control instruction according to a pressing operation of the user;
receiving, by the microcontroller module, the second control instruction,
wherein the turning on, by the microcontroller module, one of the plurality of vaporization control switches which are electrically connected to the microcontroller module in response to the trigger signal comprises:
in a case that it is detected by the microcontroller module that the trigger signal generated by the smoking switch module is received by the microcontroller module, turning on, by the microcontroller module, one of the plurality of vaporization control switches which are electrically connected to the microcontroller module for one time in response to the detected trigger signal and based on the second control instruction, wherein the plurality of vaporization control switches are turned on randomly in response to the trigger signal.

5. The electronic cigarette oil vaporization method according to claim 1, wherein the turning on, by the microcontroller module, one of the plurality of vaporization control switches which are electrically connected to the microcontroller module in response to the trigger signal comprises:
turning on, by the microcontroller module, one of the plurality of vaporization control switches which are electrically connected to the microcontroller module in response to the trigger signal, and determining, by the microcontroller module, the turned-on vaporization control switch as a target vaporization control switch;
wherein the method further comprises:
generating, by a third setting switch electrically connected to the microcontroller module, a third control instruction according to a pressing operation of the user;
receiving, by the microcontroller module, the third control instruction; and
in a case that it is detected by the microcontroller module that the trigger signal generated by the smoking switch module is received by the microcontroller module, controlling, by the microcontroller module, the target vaporization control switch to remain on in response to the detected trigger signal and based on the third control instruction.

6. The electronic cigarette oil vaporization method according to claim 1, wherein the vaporizing, by the heating wire electrically connected to the turned-on vaporization control switch, the electronic cigarette oil to supply smoke for the user to take in comprises:
determining, by the microcontroller module, a target flavor of the electronic cigarette oil vaporized by the heating wire electrically connected to the turned-on vaporization control switch;
displaying, by the microcontroller module, the target flavor in a form of text by means of a display screen electrically connected to the microcontroller module; or
playing, by the microcontroller module, the target flavor in a form of voice by means of a sound generator electrically connected to the microcontroller module.

7. An electronic cigarette control circuit for implementing an electronic cigarette oil vaporization method, the method comprising:
generating, by a smoking switch module configured to generate a trigger signal according to an operation of a user, the trigger signal according to the operation of the user;
receiving, by a microcontroller module, the trigger signal;
turning on, by the microcontroller module, one of a plurality of vaporization control switches which are electrically connected to the microcontroller module in response to the trigger signal; and
vaporizing, by a heating wire among a plurality of heating wires which is electrically connected to the turned-on vaporization control switch, electronic cigarette oil to supply smoke for the user to take in, wherein the plurality of heating wires correspond to the plurality of vaporization control switches and a variety of electronic cigarette oil respectively,
the electronic cigarette control circuit comprising: a battery, the smoking switch module, a heating wire assembly, a vaporization control switch module and the microcontroller module, wherein
the heating wire assembly comprises the plurality of heating wires;
the vaporization control switch module comprises the plurality of vaporization control switches electrically connected to the heating wires and the battery respectively; and
the microcontroller module is electrically connected to the battery, the smoking switch module and the vaporization control switch module respectively, to turn on one of the plurality of vaporization control switches which are electrically connected to the microcontroller module in response to the trigger signal.

8. The electronic cigarette control circuit according to claim 7, further comprising at least one of:
the first setting switch electrically connected to the microcontroller module and configured to enable the microcontroller module to sequentially turn on the plurality of vaporization control switches; and
the second setting switch electrically connected to the microcontroller module and configured to enable the microcontroller module to randomly turn on the plurality of vaporization control switches.

9. The electronic cigarette control circuit according to claim 7, further comprising:
the third setting switch electrically connected to the microcontroller module and configured to enable the microcontroller module to control the target vaporization control switch to remain on.

10. The electronic cigarette control circuit according to claim 8, further comprising:
the third setting switch electrically connected to the microcontroller module and configured to enable the microcontroller module to control the target vaporization control switch to remain on.

11. The electronic cigarette control circuit according to claim 9, further comprising at least one of:
the display screen electrically connected to the microcontroller module and configured to prompt to the user the target flavor of the electronic cigarette oil vaporized by the heating wire electrically connected to the turned-on vaporization control switch in a form of text; and
the sound generator electrically connected to the microcontroller module and configured to prompt to the user the target flavor of the electronic cigarette oil vaporized by the heating wire electrically connected to the turned-on vaporization control switch in a form of voice.

12. The electronic cigarette control circuit according to claim 10, further comprising at least one of:
the display screen electrically connected to the microcontroller module and configured to prompt to the user the target flavor of the electronic cigarette oil vaporized by the heating wire electrically connected to the turned-on vaporization control switch in a form of text; and
the sound generator electrically connected to the microcontroller module and configured to prompt to the user the target flavor of the electronic cigarette oil vaporized by the heating wire electrically connected to the turned-on vaporization control switch in a form of voice.

13. The electronic cigarette control circuit according to claim 7, further comprising at least one of:
a first light-emitting element electrically connected to the microcontroller module and configured to simulate a smoking scene; and
a second light-emitting element electrically connected to the microcontroller module and configured to indicate whether an operation of a user is received by the smoking switch module.

14. The electronic cigarette control circuit according to claim 7, further comprising:
a capacitor electrically connected to the microcontroller module and configured to power the microcontroller module in a case that the heating wire is shorted.

15. The electronic cigarette control circuit according to claim 7, wherein the smoking switch module is:
an airflow-sensitive switch configured to generate the trigger signal according to a smoking action of the user; or
a push-key switch configured to receive a pressing operation of the user and generate the trigger signal according to the received pressing operation.

16. The electronic cigarette control circuit according to claim 7, wherein the vaporization control switch module is:
a relay, a field effect transistor, or a triode.

17. An electronic cigarette for implementing an electronic cigarette oil vaporization method, the method comprising:
generating, by a smoking switch module configured to generate a trigger signal according to an operation of a user, the trigger signal according to the operation of the user;
receiving, by a microcontroller module, the trigger signal;
turning on, by the microcontroller module, one of a plurality of vaporization control switches which are electrically connected to the microcontroller module in response to the trigger signal; and
vaporizing, by a heating wire among a plurality of heating wires which is electrically connected to the turned-on vaporization control switch, electronic cigarette oil to supply smoke for the user to take in, wherein the plurality of heating wires correspond to the plurality of vaporization control switches and a variety of electronic cigarette oil respectively,
the electronic cigarette comprising:
an electronic cigarette body, wherein the electronic cigarette body is provided with an electronic cigarette oil receiving volume for storing the electronic cigarette oil, a vaporizer for receiving the plurality of heating wires, and a battery rod assembly configured to power the vaporizer,
wherein the battery rod assembly is provided with a battery, the microcontroller module, the smoking switch module, and the plurality of vaporization control switches which are electrically connected to the battery and the microcontroller module respectively, wherein different vaporization control switches are electrically connected to different heating wires.

18. The electronic cigarette according to claim 17, wherein
the electronic cigarette oil receiving volume is a first electronic cigarette oil bottle, wherein a plurality of first electronic cigarette oil bottles are configured to store the electronic cigarette oil with different flavors, and connected to the vaporizer to enable different heating wires to vaporize the electronic cigarette oil in different first electronic cigarette oil bottles; or
a plurality of electronic cigarette oil receiving volumes are provided in a second electronic cigarette oil bottle, wherein the plurality of electronic cigarette oil receiving volumes are isolated from each other in a sealed manner and configured to store the electronic cigarette oil with different flavors, wherein the second electronic cigarette oil bottle is connected to the vaporizer to enable different heating wires to vaporize the electronic cigarette oil in different electronic cigarette oil receiving volumes.
